(19) United States
(12) Patent Application Publication
(10) Pub. No.: US 2020/0079433 A1
(43) Pub. Date: Mar. 12, 2020

(54) VEHICLE

(71) Applicant: HONDA MOTOR CO., LTD., Tokyo (JP)

(72) Inventors: Takanori SUZUKI, Saitama (JP); Takuro TOMINAGA, Saitama (JP)

(73) Assignee: HONDA MOTOR CO., LTD., Tokyo (JP)

(21) Appl. No.: 16/567,209

(22) Filed: Sep. 11, 2019

(30) Foreign Application Priority Data
Sep. 12, 2018 (JP) 2018-170799

(51) Int. Cl. B62D 21/15; B60K 1/04; H02K 7/00

(52) U.S. Cl. CPC B62D 21/155; B60K 1/04; B60K 2001/0416; B60K 2001/0438; H02K 7/006

(57) ABSTRACT

A vehicle includes a driving device unit configured to drive a rear wheel and a rear cross member which extends in a left-right direction and supports the driving device unit. A maximum length of the driving device unit in a front-rear direction is longer than a maximum length thereof in a vehicle width direction, and a rear end portion of the driving device unit is located rearward than a wheel rear end portion of the rear wheel and forward than a rear end portion of the rear cross member.

### CROSS-REFERENCE TO RELATED APPLICATIONS

This application is based on and claims priority under 35 USC 119 from Japanese Patent Application No. 2018-170799 filed on Sep. 12, 2018.

### TECHNICAL FIELD

The present invention relates to a vehicle including a driving device unit that drives rear wheels.

### BACKGROUND ART

In the vehicle of JP-A-2009-227083, the vehicle is provided with a power plant having an electric motor for driving rear wheels, the power plant is fixed to a sub-frame via a front bracket and a rear bracket, and a wire member having a front end portion connected to the power plant and a rear end portion connected to the sub-frame is also provided. According to JP-A-2009-227083, this configuration can prevent the electric motor from colliding with a power source provided at a front side of the electric motor even when an electric vehicle has a front or rear collision.

However, in the vehicle described in JP-A-2009-227083, the number of collision countermeasure components is large, resulting in an increase in manufacturing costs. Further, since a sufficient space is required between a rear side of the electric motor and the sub frame, an occupant space may become narrow.

### SUMMARY

An aspect of the present invention provides a vehicle capable of appropriately protecting a driving device unit at the time of a rear collision while ensuring a wide occupant space.

An embodiment of the present invention relates to a vehicle which includes:

a driving device unit which is configured to drive a rear wheel; and

a rear cross member extending in a left-right direction and supports the driving device unit, and

a maximum length of the driving device unit in a front-rear direction is longer than a maximum length thereof in a vehicle width direction, and

a rear end portion of the driving device unit is located rearward than a wheel rear end portion of the rear wheel and forward than a rear end portion of the rear cross member.

### Advantageous Effects of Invention

According to one aspect of the present invention, since the rear end portion of the driving device unit is located rearward than the wheel rear end portions of the rear wheels, it is possible to ensure a wide vehicle interior as the occupant space.

Further, since the rear end portion of the driving device unit is located forward than the rear end portion of the rear cross member, even when the driving device unit is disposed on a rear portion of the vehicle, the driving device unit can be protected by the rear cross member in a rear collision. Further, by making a maximum length of the driving device unit in the front-rear direction longer than a maximum length thereof in the vehicle width direction, deformation of a vehicle frame member can be allowed, and the driving device unit can be more reliably protected.

### BRIEF DESCRIPTION OF DRAWINGS

FIG. 1 is a schematic side view showing an overall structure of a vehicle according to an embodiment of the present invention.

FIG. 2 is a plan view showing an underfloor structure of the vehicle in FIG. 1.

FIG. 3 is a plan view of a driving device unit and a periphery thereof of the vehicle in FIG. 1.

FIG. 4 is a perspective view of the driving device unit and the periphery thereof of the vehicle in FIG. 1.

FIG. 5 is a bottom view of the driving device unit and the periphery thereof of the vehicle in FIG. 1.

### DESCRIPTION OF EMBODIMENTS

Hereinafter, a vehicle according to an embodiment of the present invention will be described with reference to the drawings. The drawings should be seen based on a direction of reference numerals. In the following description, front, rear, left, right, upper, and lower directions are described according a view from an operator. In the drawings, a front side of the vehicle is denoted by Fr, a rear side is denoted by Rr, a left side is denoted by L, a right side is denoted by R, an upper side is denoted by U, and a lower side is denoted by D.

[Overall Structure of Vehicle]

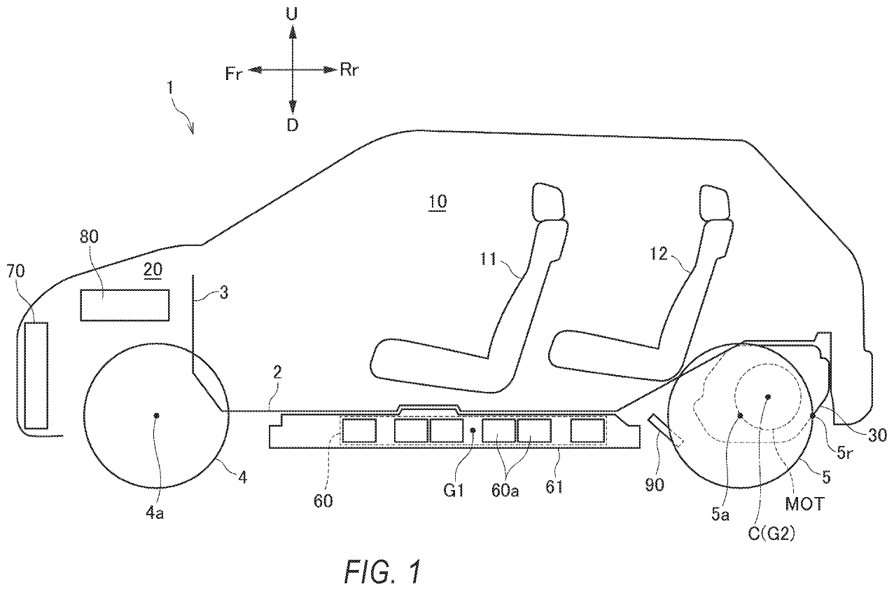

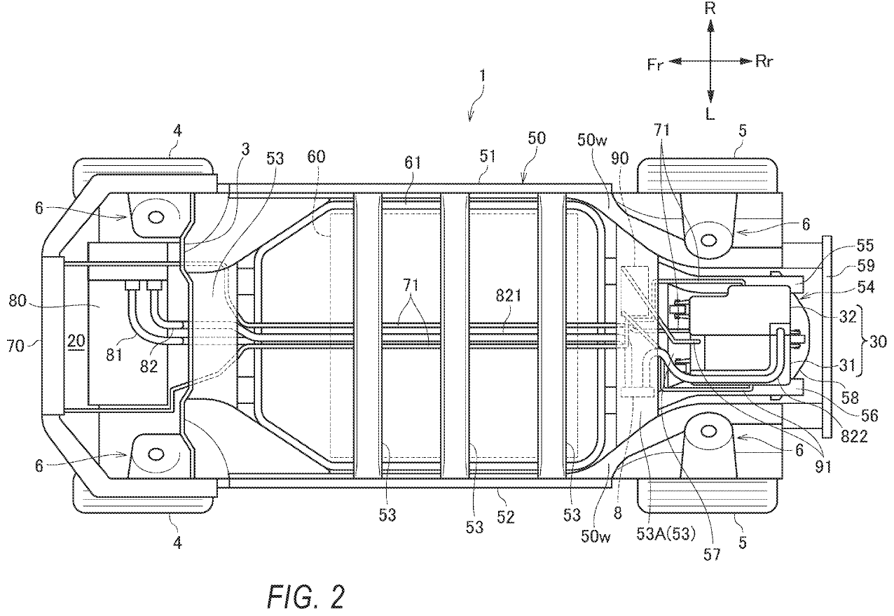

As shown in FIGS. 1 and 2, a vehicle 1 according to an embodiment of the present invention is formed by a vehicle interior 10 and a front room 20 in front of the vehicle interior 10, which are defined by a floor panel 2 and a dash panel 3. A front seat 11 and a rear seat 12 are provided in the vehicle interior 10. A driving device unit 30 is provided below the floor panel 2 at a rear side of the rear seat 12. The driving device unit 30 drives rear wheels 5. That is, in the vehicle 1, the rear wheels 5 are driving wheels, and front wheels 4 are driven wheels. The front wheels 4 and the rear wheels 5 are supported by a vehicle body frame 50 via a suspension (not shown) supported by respective suspension support portions 6.

The vehicle body frame 50 includes a pair of left and right side members 51, 52 extending in a front-rear direction, a plurality of cross members 53 extending in a left-right direction and connecting the side members 51, 52, a sub-frame 54 having a rectangular shape so as to surround the driving device unit 30, and a rear cross member 59 located rearward than the sub-frame 54. The sub-frame 54 includes a pair of sub-side members 55, 56 supported by the side members 51, 52, a front cross member 57 and a rear cross member 58 that connect the pair of sub side members 55, 56.

[Driving Device Unit]

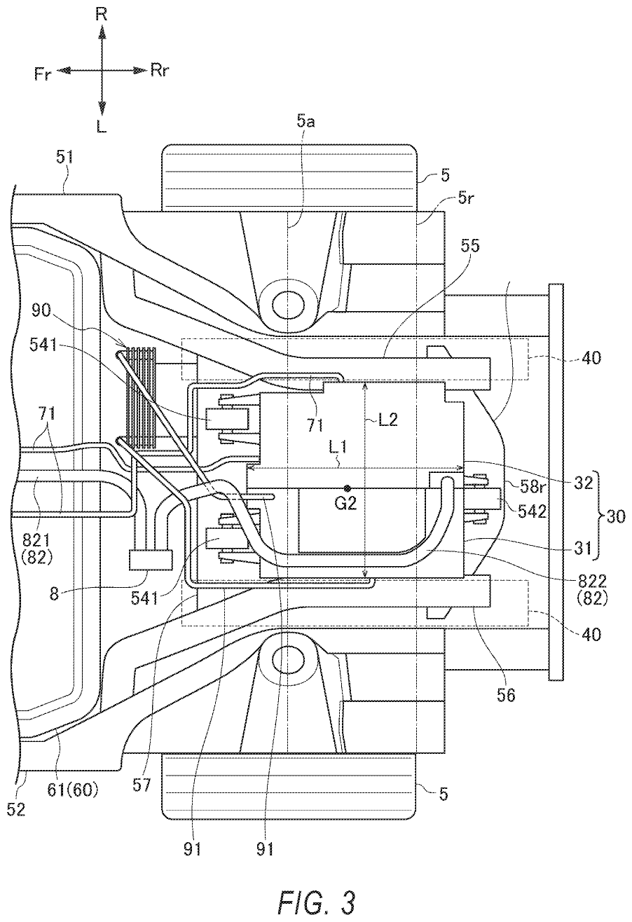

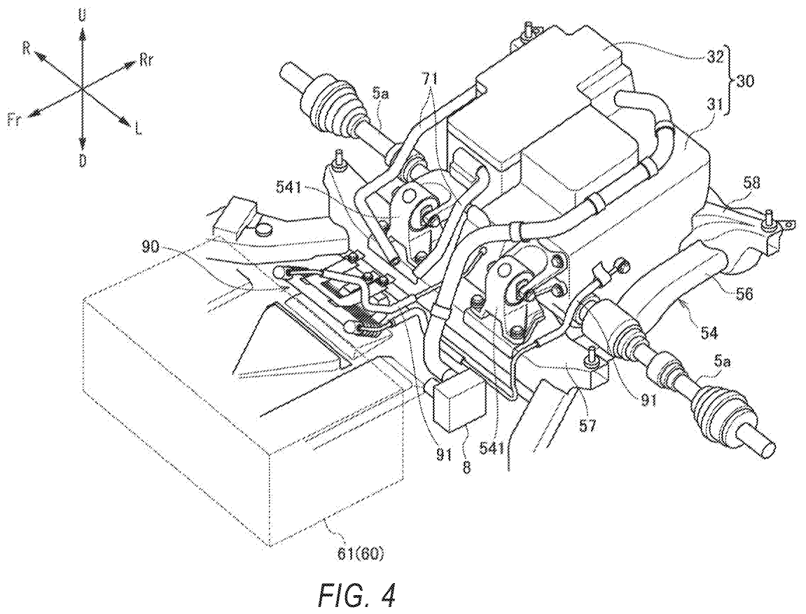

As shown in FIGS. 3 and 4, the driving device unit 30 is fixed to the rear cross member 58 extending in the left-right direction via a rear mounting portion 542, and is fixed to the front cross member 57 extending in the left-right direction via a pair of front mounting portions 541. The driving device unit 30 includes a driving device 31 that accommodates a motor MOT as an electric motor and a Power Control Unit (PCU) 32 as an electric motor control unit that controls the motor MOT. The driving device 31 and the PCU 32 are electrically connected via a bus bar (not shown).

The driving device 31 is provided with a transmission (not shown), and torque of the motor MOT is transmitted to a rear wheel axle 5a via the transmission, and is transmitted from the rear wheel axle 5a to the rear wheels 5. The driving device 31 and the PCU 32 are disposed side by side in a width direction of the vehicle 1 in a top view. The PCU 32 is disposed above the sub-frame 54.

Referring also to FIG. 2, the PCU 32 is electrically connected to a junction box 80 provided in a front room 20 via a PCU cable 82. The PCU cable 82 includes a first cable 821 extending from the junction box 80 and a second cable 822 extending from the PCU 32. The first cable 821 and the second cable 822 are connected to each other via a joint box 8 fixed to a lower surface of the cross member 53 (hereinafter, the cross member 53 is called a support cross member 53A) located between a battery 60 and the driving device unit 30. In FIG. 2, reference numeral 81 denotes a battery cable that electrically connects the junction box 80 with the battery 60.

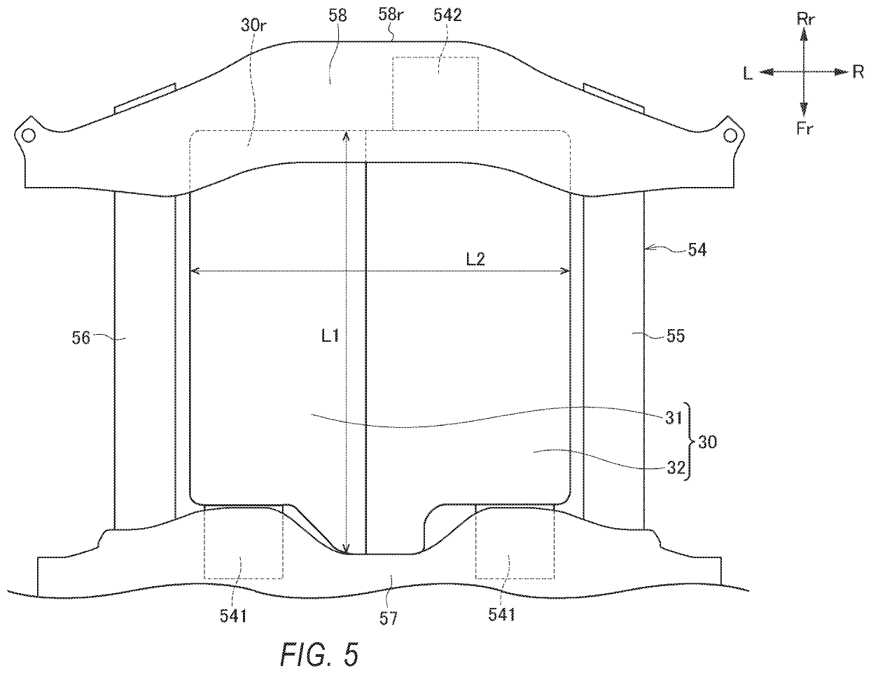

As shown in FIGS. 3 and 5, a maximum length L1 of the driving device unit 30 in the front-rear direction is longer than a maximum length L2 in the vehicle width direction, and a rear end portion 30r of the driving device unit 30 is located rearward than wheel rear end portions 5r of the rear wheels 5 and forward than a frame rear end portion 58r of the rear cross member 58. That is, the rear end portion 30r of the driving device unit 30 overlaps the rear cross member 58. Since the rear end portion 30r of the driving device unit 30 overlaps the rear cross member 58, the rear cross member 58 of the sub-frame 54 can firmly bear a rear load of the driving device unit 30. The wheel rear end portion 5r of the rear wheel 5 is a rear end portion of the wheel on which a tire is mounted.

Referring back to FIG. 1, a rotation axis C of the motor MOT is located rearward than the rear wheel axle 5a connecting the left and right rear wheels 5, and a center of gravity G2 of the driving device unit 30 is also located rearward than the rear wheel axle 5a. By disposing the motor MOT which is a rigid body such that the rotation axis C is located rearward than the rear wheel axle 5a, the vehicle interior 10, which is the occupant space, can be more reliably protected from an impact in the rear-end collision. Further, by locating the center of gravity G2 of the driving device unit 30 rearward than the rear wheel axle 5a, a load pressing the rear wheels 5 increases. Accordingly, relative displacement of the rear wheel axle 5a with respect to the driving device unit 30 in an upper-lower direction is suppressed, and a load transmission to the rear wheel axle 5a can be stabilized. Further, acceleration performance can be improved by increasing the load pressing the rear wheels 5. Although the rotational axis C of the motor MOT is defined as the center of gravity G2 of the driving device unit 30 in FIG. 1, the center of gravity G2 of the driving device unit 30 may deviate from the rotational axis C of the motor MOT in practice.

[Battery]

As shown in FIG. 1, the battery 60 including a plurality of battery modules 60a is disposed below the vehicle interior 10. The battery 60 is accommodated in a battery case 61 and is disposed below the floor panel 2. A center of gravity G1 of the battery 60 is located rearward than the front wheel axle 4a connecting the left and right front wheels 4, and is located forward than the rear wheel axle 5a.

As shown in FIG. 2, on the pair of side members 51, 52 which are on an outer side in the vehicle width direction of the battery 60 and the driving device unit 30 and extend in the front-rear direction, fragile portions 50w are provided at locations rearward than the battery 60 and forward than the rear wheel axle 5a By making the strength of the side members 51, 52 at other portions higher than that of the side members 51, 52 located between the battery 60 and the rear wheel axle 5a, the impact can be absorbed by positively crushing the fragile portions 50w while the driving device unit 30 and the battery 60 in the rear-end collision is protected.

[Ventilation Passage]

As shown in FIG. 3, ventilation passages 40 extending in the front-rear direction are provided between the driving device unit 30 and the pair of side members 51, 52. Since the maximum length L1 of the driving device unit 30 in the front-rear direction is longer than the maximum length L2 in the vehicle width direction, a wide gap can be ensured between the driving device unit 30 and the pair of side members 51, 52. Since the driving device unit 30 is covered with the floor panel 2 as described above, a flow path of traveling wind is formed, and a decrease in cooling performance due to the diffusion of the traveling wind can be suppressed. Since the ventilation passages 40 are provided between the driving device unit 30 and the pair of side members 51, 52 as described above, the driving device unit 30 can be cooled by the traveling wind passing through the ventilation passages 40. Further, radio noise transmitted from the driving device unit 30 to a vehicle body can be reduced.

As described above, since the PCU 32 is disposed above the sub-frame 54, the traveling wind can be surely blown toward the PCU 32 having a strict management temperature, and the cooling performance can be improved.

A cooling piping 71 connected to a cooling flow path of the PCU 32 is disposed in the ventilation passage 40 formed between the driving device unit 30 and the side member 51, and a refrigerant pipe 91 connected to a cooling flow path of the driving device 31 is disposed in the ventilation passage 40 formed between the driving device unit 30 and the side member 52. By disposing the cooling piping 71 and the refrigerant pipe 91 in the ventilation passages 40, a refrigerant can be cooled by the traveling wind. In particular, the cooling performance can be improved by disposing the cooling piping 71 of the PCU 32 having the strict management temperature in the ventilation passage 40. Hereinafter, a first cooling device 70 that cools the PCU 32 and a second cooling device 90 that cools the driving device 31 will be described.

[First Cooling Device]

As shown in FIG. 1, the first cooling device 70 for cooling the PCU 32 is provided in the front room 20. The first cooling device 70 includes a radiator provided at a forefront of the vehicle 1. As shown in FIG. 2, the first cooling device 70 and the PCU 32 are connected by the cooling piping 71 disposed between the floor panel 2 and the battery 60 (battery case 61). The PCU 32 is cooled by circularly supplying the refrigerant cooled by the first cooling device 70 through the cooling piping 71.

[Second Cooling Device]

As shown in FIGS. 3 and 4, the second cooling device 90 that cools the driving device 31 is disposed below the floor panel 2 and between the sub-frame 54 and the battery 60. The second cooling device 90 includes a radiator. The second cooling device 90 is connected to the driving device 31 via the refrigerant pipe 91. The driving device 31 is cooled by circularly supplying the refrigerant (ATF) cooled by the second cooling device 90 through the refrigerant pipe 91.

In this way, by separately disposing the first cooling device 70 and the second cooling device 90 in the front-rear direction of the vehicle 1, it is possible to suppress the transmission of heat from one cooling device to the other cooling device. Further, the first cooling device 70 for cooling the PCU 32 which has a stricter management temperature and requires the cooling performance is disposed in the front room 20, and the traveling wind is easily blown toward the PCU 32, so that the PCU 32 can be appropriately cooled. On the other hand, by disposing the second cooling device 90 that cools the driving device 31 having a high exhaust heat temperature below the floor panel 2, the temperature rise in the front room 20 can be suppressed.

The above-described embodiment may be appropriately modified, improved, or the like.

At least the following matters are described in this specification. Although corresponding constituent elements or the like in the above-described embodiment are illustrated in parentheses, the present invention is not limited thereto.

(1) A vehicle (vehicle 1) includes:

a driving device unit (driving device unit 30) which is configured to drive a rear wheel (rear wheel 5); and

a rear cross member (rear cross member 58) extending in a left-right direction and supports the driving device unit,

wherein a maximum length (L1) of the driving device unit in a front-rear direction is longer than a maximum length (L2) thereof in a vehicle width direction, and

wherein a rear end portion (rear end portion 30r) of the driving device unit is located rearward than a wheel rear end portion (wheel rear end portion 5r) of the rear wheel and forward than a rear end portion (frame rear end portion 58r) of the rear cross member.

According to (1), since the rear end portion of the driving device unit is located rearward than the wheel rear end portion of the rear wheel, a wide vehicle interior as the occupant space can be ensured. Further, since the rear end portion of the driving device unit is located forward than the rear end portion of the rear cross member, even when the driving device unit is disposed on a rear portion of the vehicle, the driving device unit can be protected by the rear cross member in a rear-end collision.

Further, by making a maximum length of the driving device unit in the front-rear direction longer than a maximum length thereof in the vehicle width direction, deformation of a vehicle frame member can be allowed, and the driving device unit can be more reliably protected.

(2) In the vehicle according to (1),

the driving device unit includes an electric motor (motor MOT) driving the rear wheel,

a rotation axis (rotation axis C) of the electric motor is located rearward than a rear wheel axle (rear wheel axle 5a), and

a center of gravity (center of gravity G2) of the driving device unit is located rearward than the rear wheel axle.

According to (2), by disposing the electric motor which is a rigid body such that the rotation axis is located rearward than the rear wheel axle, the vehicle interior, which is the occupant space, can be more reliably protected from an impact in the rear-end collision. Further, by locating the center of gravity of the driving device unit rearward than the rear wheel axle, a load pressing the rear wheel increases. Accordingly, relative displacement of the rear wheel axle with respect to the driving device unit in an upper-lower direction is suppressed, and a load transmission to the rear heel axle can be stabilized. Further, acceleration performance can be improved by increasing the load pressing the rear wheel.

(3) In the vehicle according to (1) or (2),

the vehicle includes:
a battery (battery 60) provided below a vehicle interior (vehicle interior 10) and below a floor panel (floor panel 2); and
a pair of side members (side members 51, 52) which are on an outer side in the vehicle width direction of the battery and the driving device unit and extend in the front-rear direction, and

each of the pair of side members includes a fragile portion (fragile portion 50w) located rearward than the battery and forward than a rear wheel axle (rear wheel axle 5a).

According to (3), by making the strength of the side members at positions where the driving device unit and the battery are held stronger than the strength of the side members located between the battery and the rear wheel axle, the impact can be absorbed by positively crushing the fragile portions while protecting the driving device unit and the battery in the rear-end collision.

(4) In the vehicle according to any one of (1) to (3),

the driving device unit is disposed between the pair of side members (side members 51, 52), and

ventilation passages (ventilation passages 40) extending in a front-rear direction are provided between the driving device unit and the pair of side members.

According to (4), the driving device unit can be cooled by the traveling wind passing through the ventilation passages. Further, radio noise transmitted from the driving device unit to a vehicle body can be reduced.

(5) In the vehicle according to (4),

the driving device unit includes:
a driving device (driving device 31) accommodating an electric motor; and
an electric motor control device (PCU 32) configured to control the electric motor, and

a cooling piping (cooling piping 71) connected to a cooling flow path of the electric motor control device is disposed in the ventilation passages.

According to (5), the cooling performance can be improved by disposing the cooling piping of the electric motor control device having a strict control temperature in the ventilation passage.

(6) In the vehicle according to any one of (1) to (5),

the driving device unit is supported by a sub-frame (sub-frame 54), and the sub-frame has a rectangular shape so as to surround the driving device unit and including the rear cross member,

the driving device unit includes:
a driving device (driving device 31) accommodating an electric motor; and
an electric motor control device (PCU 32) configured to control the electric motor, and

the electric motor control device is located above the sub-frame.

According to (6), traveling wind can be surely blown toward the electric motor control device having a strict management temperature, and the cooling performance can be improved.

(7) In the vehicle according to any one of (4) to (6),

the driving device unit is provided below a floor panel (floor panel 2).

According to (7), since the driving device unit is covered with the floor panel, a flow path of the traveling wind is formed, and a decrease in the cooling performance due to the diffusion of the traveling wind can be suppressed.

1. A vehicle comprising:
a driving device unit which is configured to drive a rear wheel; and
a rear cross member extending in a left-right direction and supports the driving device unit,
wherein a maximum length of the driving device unit in a front-rear direction is longer than a maximum length thereof in a vehicle width direction, and
wherein a rear end portion of the driving device unit is located rearward than a wheel rear end portion of the rear wheel and forward than a rear end portion of the rear cross member.

2. The vehicle according to claim 1,
wherein the driving device unit includes an electric motor configured to drive the rear wheel,
wherein a rotation axis of the electric motor is located rearward than a rear wheel axle, and
wherein a center of gravity of the driving device unit is located rearward than the rear wheel axle.

3. The vehicle according to claim 1 further comprising:
a battery which is provided below a vehicle interior and below a floor panel; and
a pair of side members which are on an outer side in the vehicle width direction of the battery and the driving device unit and extend in the front-rear direction, and
wherein each of the pair of side members includes a fragile portion located rearward than the battery and forward than a rear wheel axle.

4. The vehicle according to claim 1,
wherein the driving device unit is disposed between a pair of side members, and
wherein ventilation passages extending in a front-rear direction are provided between the driving device unit and the pair of side members.

5. The vehicle according to claim 4,
wherein the driving device unit includes:
a driving device accommodating an electric motor; and
an electric motor control device configured to control the electric motor, and
wherein a cooling piping connected to a cooling flow path of the electric motor control device is disposed in the ventilation passages.

6. The vehicle according to claim 1,
wherein the driving device unit is supported by a sub-frame, the sub-frame having a rectangular shape so as to surround the driving device unit and including the rear cross member,
wherein the driving device unit includes:
a driving device configured to accommodate an electric motor; and
an electric motor control device configured to control the electric motor, and
wherein the electric motor control device is located above the sub-frame.

7. The vehicle according to claim 4,
wherein the driving device unit is provided below a floor panel.
